(19) United States
(12) Patent Application Publication
(10) Pub. No.: US 2026/0098969 A1
(43) Pub. Date: Apr. 9, 2026

(54) SYSTEMS AND METHODS FOR GLOBAL NAVIGATION SATELLITE SYSTEM (GNSS) AND NON-TERRESTRIAL NETWORK (NTN) COMMUNICATION

(71) Applicant: Samsung Electronics Co., Ltd., Suwon-si (KR)

(72) Inventors: Jie Wu, San Diego, CA (US); Sigang Qiu, Sunnyvale, CA (US); Jusang Park, San Diego, CA (US)

(21) Appl. No.: 19/018,814

(22) Filed: Jan. 13, 2025

Related U.S. Application Data
(60) Provisional application No. 63/704,806, filed on Oct. 8, 2024.

(51) Int. Cl. G01S 19/21; G01S 19/32; H04B 7/185

(52) U.S. Cl. CPC G01S 19/21; G01S 19/32; H04B 7/18513

(57) ABSTRACT

A method includes identifying a first trigger condition by a device configured with a global navigation satellite system (GNSS) communication mode and a non-terrestrial network (NTN) communication mode, based on identifying the first trigger condition, changing a transmission attribute of the NTN communication mode to a first transmission state and enabling reception of a signal received via the GNSS communication mode, detecting a second trigger condition associated with the GNSS communication mode or the NTN communication mode, and based on detecting the second trigger condition, changing the transmission attribute of the NTN communication mode to a second transmission state.

### CROSS-REFERENCE TO RELATED APPLICATION

This application claims the priority benefit under 35 U.S. C. § 119(e) of U.S. Provisional Application No. 63/704,806, filed on Oct. 8, 2024, the disclosure of which is incorporated by reference in its entirety as if fully set forth herein.

### TECHNICAL FIELD

The disclosure generally relates to communication modalities of electronic devices. More particularly, the subject matter disclosed herein relates to global navigation satellite system (GNSS) and non-terrestrial network (NTN) communication modalities of electronic devices.

### SUMMARY

Electronic devices including mobile communication devices such as smartphones may have one or more communication modalities (or modes). Some devices, for example, may have both a global navigation satellite system (GNSS) communication modality and a non-terrestrial network (NTN) communication modality. A GNSS module may control communication that uses the GNSS communication modality. The GNSS module may include at least two receivers to enable the GNSS communication, commonly referred to as a GNSS L1 receiver and a GNSS L5 receiver. The GNSS L1 receiver may receive data on a frequency band that is substantially close to the frequency band on which the NTN antenna transmits. For example, a GNSS L1 band may range from about 1561 MHz to about 1604 MHz, while an NTN uplink frequency may range from about 1626.5 MHz to about 1660.5 MHz. For devices that support both NTN and GNSS communication modes, the GNSS L1 band can be impacted by NTN transmission signals. In some cases, the radio frequency interference from the NTN transmission signals may be strong enough to render the GNSS L1 band unusable (or negatively impact operation of the GNSS L1 band) during NTN transmission.

To solve this problem, an electronic device may use the GNSS communication mode and the NTN communication mode in sequence to avoid any possible conflicts. If the GNSS communication mode is invoked concurrently with a transmission operation on the NTN communication mode, the electronic device may utilize the GNSS L5 antenna alone while NTN transmission is occurring, since the GNSS L5 band is generally not impacted by NTN transmission signals.

One issue with the above approaches is that the communication capabilities of the electronic device may be restricted by avoiding concurrent use of the GNSS and NTN communication modes, or by limiting the GNSS communication mode to only use the L5 receiver when the NTN communication mode is also enabled. Communication using the GNSS L5 receiver may be less desirable than communication using the GNSS L1 receiver. For example, the GNSS L5 receiver may be more susceptible to obstructions and atmospheric interference such as buildings, trees, other structures, weather, and the like. Additionally, the GNSS L5 receiver operates on a relatively newer frequency band compared to the GNSS L1 receiver, and may have less global coverage and signal availability. Thus, relying on the GNSS L5 receiver alone may not adequately remedy the loss of GNSS L1 capabilities during NTN transmission.

To overcome these issues, systems and methods are described herein for coexistence (or coordinated operation) of GNSS and NTN communication modalities in an electronic device. In some embodiments, the electronic device includes hardware and/or software interface between the GNSS module and an NTN module for coordination between NTN transmission via the NTN module, and data reception via the GNSS module.

In some embodiments, the coordinating by the interface includes receiving and transmitting requests or notification signals to and from the NTN and GNSS modules. For example, the GNSS module may send a request to the NTN module to halt NTN transmission to allow the GNSS module to receive data on the GNSS L1 frequency band. The NTN module may also send a signal to the GNSS module with information of an upcoming transmission in order to indicate that GNSS reception on the L1 band may be degraded and thus turned off or the data eliminated.

In some embodiments, the electronic device includes a scheduling engine configured to control prioritization and/or scheduling (collectively referenced as scheduling) between GNSS reception and NTN transmission. The scheduling may be based on one or more factors, conditions, prioritization schemes, rules, contextual information about the device or usage pattens, among others.

The above approaches improve on previous methods because such techniques enable the GNSS module to utilize the GNSS L1 receiver to receive data while minimizing or avoiding interference from the NTN transmission, which may increase reliability of data received by the GNSS L1 receiver. Advantages of the present techniques support concurrent GNSS and NTN operations. The techniques allow the GNSS communication mode and the NTN communication mode to operate in sync with each other, with a coordinated activation/deactivation scheme. This provides the GNSS communication mode with controllable windows for substantially interference-free L1 processing. This solves the limitation of L5-only solution, while significantly reducing the impact to NTN.

In one or more embodiments, a method comprises identifying a first trigger condition by a device configured with a global navigation satellite system (GNSS) communication mode and a non-terrestrial network (NTN) communication mode, based on identifying the first trigger condition, changing a transmission attribute of the NTN communication mode to a first transmission state and enabling reception of a signal received via the GNSS communication mode, detecting a second trigger condition associated with the GNSS communication mode or the NTN communication mode; and based on detecting the second trigger condition, changing the transmission attribute of the NTN communication mode to a second transmission state.

In some embodiments, transmission by the NTN communication mode is disabled or set to a power level that satisfies a threshold in the first transmission state and enabled in the second transmission state.

In some embodiments, the signal is received by a GNSS L1 antenna or receiver.

In some embodiments, the first trigger condition includes receiving a request to operate the NTN communication mode in the first transmission state.

In some embodiments, the first trigger condition includes receiving positional data at a first GNSS receiver associated with the GNSS communication mode.

In some embodiments, the second trigger condition includes receiving a notification associated with initiation of transmission on the NTN communication mode.

In some embodiments, the second trigger condition includes a completion of the reception of the signal.

In some embodiments, the second trigger condition includes the end of an identified duration of time.

In one or more embodiments, a device comprises a first global navigation satellite system (GNSS) module, a non-terrestrial network (NTN) module, a processor; and a memory. The memory stores instructions that, when executed by the processor, cause the processor to identify a first trigger condition, based on identifying the first trigger condition, change a transmission attribute of the NTN module to a first transmission state and enabling reception of a signal received via the GNSS module, detect a second trigger condition associated with the GNSS module or the NTN module, and based on detecting the second trigger condition, change the transmission attribute of the NTN module to a second transmission state.

In some embodiments, transmission by the NTN module is disabled in the first transmission state and enabled in the second transmission state.

In some embodiments, the signal is received by a GNSS L1 antenna or receiver.

In some embodiments, the first trigger condition includes receiving a request to operate the NTN module in the first transmission state.

In some embodiments, the first trigger condition includes receiving positional data at a first GNSS receiver associated with the GNSS communication mode.

In some embodiments, the second trigger condition includes receiving a notification associated with initiation of transmission on the NTN module.

In some embodiments, the second trigger condition includes a completion of the reception of the signal.

In some embodiments, the second trigger condition includes the end of an identified duration of time.

In one or more embodiments, a device comprises a first global navigation satellite system (GNSS) receiver, a non-terrestrial network (NTN) antenna, one or more processors; and at least one memory storing instructions that, when executed by the one or more processors, cause the processor to receive a request associated with the GNSS receiver, initiate a transmission gap associated with the NTN antenna, initiate reception of a signal received via the GNSS receiver, detect a trigger condition, and based on detecting the trigger condition, enabling transmission by the NTN antenna.

In some embodiments, wherein the request includes a requested duration of the transmission gap.

In some embodiments, wherein the trigger condition includes a completion of the reception of the signal.

In some embodiments, wherein the trigger condition includes the end of an identified duration of time.

In some embodiments, wherein the trigger condition includes a second request associated with the NTN antenna.

### BRIEF DESCRIPTION OF THE DRAWING

In the following section, the aspects of the subject matter disclosed herein will be described with reference to exemplary embodiments illustrated in the figures, in which:

FIG. 1 depicts a block diagram of an example electronic device with GNSS and NTN communications according to one or more embodiments;

FIG. 2 depicts a communication flow between a GNSS communication module and an NTN communication module to disable NTN communication according to one or more embodiments;

FIG. 3 depicts a communication flow between an NTN communication module and a GNSS communication module to alert a GNSS module that NTN transmission is about to begin, according to one or more embodiments;

FIG. 4 depicts a flow diagram for GNSS and NTN communications according to one or more embodiments;

FIG. 5 depicts a flow diagram of a process executed by a scheduling engine to prioritize GNSS communication over an NTN communication according to one or more embodiments;

FIG. 6 depicts a flow diagram of a process executed by the scheduling engine to prioritize NTN communication over GNSS communication according to one or more embodiments;

FIG. 7 depicts a flow diagram of a process executed by a scheduling engine for monitoring conditions for prioritizing GNSS communication over an NTN communication according to one or more embodiments;

FIG. 8 is a block diagram of an electronic device in a network environment, according to an embodiment; and

FIG. 9 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

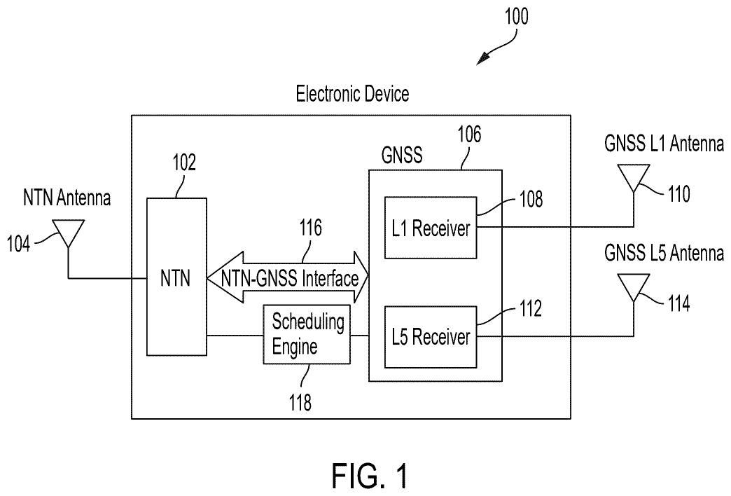

FIG. 1 depicts a block diagram of an example electronic device 100 with a global navigation satellite system (GNSS) communication modality and a non-terrestrial network (NTN) communication modality, according to one or more embodiments. In some embodiments, the device 100 includes an NTN module 102 which supports the NTN communication mode and a GNSS module 106 that supports the GNSS communication mode. The NTN module 102 may include an NTN antenna 104 through which the NTN module 102 can transmit data on an NTN frequency band. For example, the NTN band may have an uplink frequency range from about 1626.5 MHz to about 1660.5 MHz.

The GNSS module 106 may include at a GNSS L1 antenna 110 and an L1 receiver 108. In some embodiments, the GNSS module 106 also includes a GNSS L5 antenna 114 and L5 receiver 112. The GNSS L1 receiver 108 may receive data on a frequency band that is substantially close to the frequency band on which the NTN antenna transmits. For example, a GNSS L1 band may range from about 1561 MHz to about 1604 MHz. For devices that support both NTN and GNSS communication modes, the GNSS L1 band can be impacted by NTN transmission signals. In some cases, the radio frequency interference from the NTN transmission signals may be strong enough to render the GNSS L1 band unusable (or negatively impact operation of the GNSS L1 band) during NTN transmission.

In some embodiments, the electronic device 100 further includes an NTN-GNSS interface 116, through which the NTN module 102 and the GNSS module 106 can communicate with each other and coordinate operations between NTN transmission and data reception via the L1 antenna. The NTN-GNSS interface 116 may be implemented via software, hardware, firmware, or any combination thereof. In some embodiments, the NTN-GNSS interface 116 is configured to receive a request or signal from the GNSS module 106 and forward the request to the NTN module 102 to signal the NTN module 102 to halt NTN transmission and allow the GNSS module 106 to receive data on the GNSS L1 band. In some embodiments, the request sent by the GNSS module 106 includes on or more parameters, such as a requested duration for halting the NTN transmission.

The NTN-GNSS interface 116 may also be configured to receive a request or signal from the NTN module 102 and forward the request to the GNSS module 106 to notify the GNSS module of an upcoming NTN transmission. In some embodiments, receipt of the request from the NTN module 102 triggers the GNSS module 106 to halt processing of GNSS L1 band data so that data degraded by NTN interference is not utilized. In some embodiments, the notification sent by the NTN module 102 may include parameters such as the band/channel of the upcoming transmission, bandwidth, power, duty cycle, duration, and/or the like. In some embodiments, based on these parameters, the GNSS module 106 may determine whether the NTN transmission is likely to impact the L1 receiver 108. For example, L1 processing may be able to operate as is if the band/channel of the NTN transmission is far from the GNSS L1 signal band, if the power of the transmission is low enough (e.g., below a threshold). In another example, the GNSS module may blank the data received if the duty cycle of the NTN transmission is small enough (e.g., below a threshold) or the duration of the transmission is short enough (e.g., below a threshold).

In some embodiments, when a transmission notification from the NTN module is received by the GNSS module 106, the GNSS module may take an action to decrease a risk of interference with the NTN transmission. Such actions may include, for example, blanking or disabling L1 band reception, operating as an L5-only solution, or aligning a GNSS L1 band operation with the NTN transmission timeline.

In some embodiments, the electronic device 100 includes a scheduling engine 118. The scheduling engine 118 may be configured to control prioritization and/or scheduling (collectively referenced as scheduling) between GNSS L1 reception and NTN transmission. The scheduling engine 118 may be implemented as software, hardware, firmware, or any combination thereof. For example, functionality of the scheduling engine 118 may be provided via a processor with instructions stored in memory. The processor may be a central processing unit (CPU), field-programmable gate array (FPGA), graphics processing unit (GPU), or the like. In some embodiments, the scheduling engine is configured to arbitrate between the GNSS L1 reception or NTN transmission at a given time based on one or more criteria. For example, the GNSS module 106 may make a request to the scheduling engine 118 to disable NTN transmission and enable GNSS L1 reception. The scheduling engine 118 may evaluate one or more conditions associated with the GNSS communication mode, the NTN communication mode, and/or other aspects of the device or usage of the device to determine whether to satisfy the request and turn off NTN transmission.

In some embodiments, the scheduling engine 118 is configured to receive and evaluate a request from the NTN module 102 to turn off GNSS reception and enable NTN transmission. The evaluation may include the type of data to be received by the GNSS L1 antenna, the type of data being or to be transmitted by the NTN module 102, whether the NTN transmission is associated with an emergency-type transmission, how much time has passed since data was last received by the GNSS L1 antenna, how much time has passed since data was last transmitted by the NTN module, the current location of the device, and/or the like. In some embodiments, the evaluation includes the status of currently stored GNSS data such as a GNSS ephemeris or positional fixes. Additional situational information or data associated with the device or usage of the device, may also be used in the evaluation, such as remaining battery life, whether there are other devices within the vicinity, whether the device is moving quickly, whether an application requiring GNSS data is active, and/or the like.

In some embodiments, the scheduling engine 118 monitors the one or more conditions to switch from one more of communication to another (e.g., from enabling L1 reception to enabling NTN transmission, or vice versa).

Embodiments of the electronic device 100 may include the NTN-GNSS interface 116, the scheduling engine 118, or both. In some embodiments, the NTN-GNSS interface performs some or all of the tasks described above with respect to the scheduling engine 118. In some embodiments, the scheduling engine 118 performs some or all of the tasks described above with respect to the NTN-GNSS interface 116.

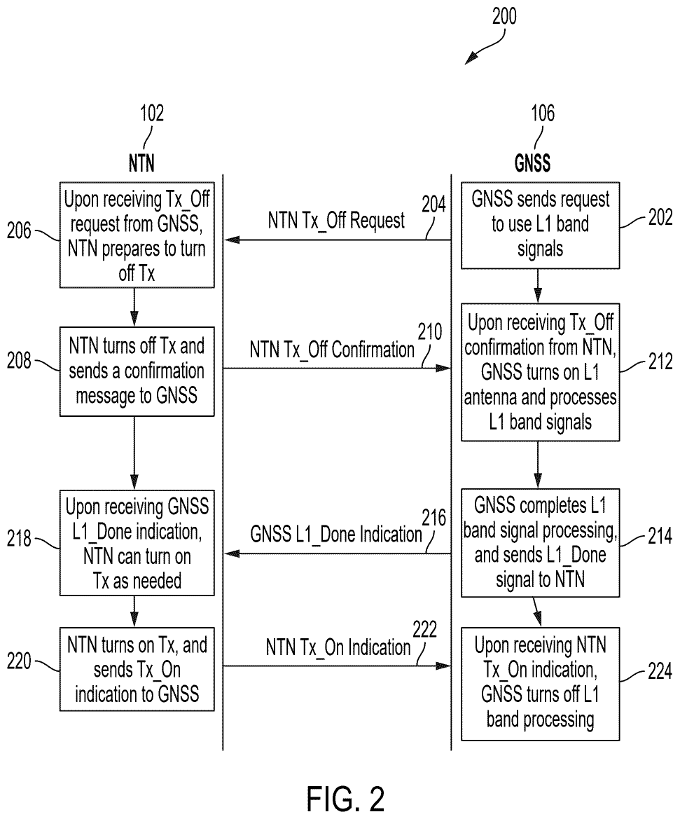

FIG. 2 depicts a communication flow 200 between the GNSS module 106 and the NTN module 102 over the NTN-GNSS interface 116 to disable NTN communication according to one or more embodiments. At action 202, the GNSS module 106 sends a request 204 to the NTN module 102 to turn off NTN transmission so the GNSS module can use L1 band signals. The request 204 may include various parameters such a requested duration for halting NTN transmission, a requested start-time for halting NTN transmissions, a threshold NTN transmission power, among others. In some embodiments, the requested start-time for halting NTN transmission may be used to synchronize NTN operation and GNSS operation. The requested duration for halting NTN transmission may be used to set a time at which NTN may transmit again.

At action 206, upon receiving the request 204 to turn off transmission, the NTN module 102 prepares to turn off transmission. For example, the NTN transmission module may finish transmitting one or more data packages such that transmission can be halted at a good stopping point by the requested time stamp from the GNSS request. In some embodiments, the NTN module 102 initializes a timer that controls when to turn off transmission, and when to allow transmission again. The NTN module 102 may communicate with the recipient of the NTN transmission about the upcoming interruption and when to expect to receive transmission again.

At action 208, the NTN module 102 turns off transmission and sends a confirmation message 210 to the GNSS module 106. For example, the NTN module 202 may turn off power to a transmitter in the NTN module 102. In some embodiments, turning off NTN transmission may be implemented by simulating a scenario as if the NTN signal is experiencing severe signal-to-noise ratio (SNR) loss. In some embodiments, the NTN module may keep NTN transmission on, but with transmission power level that is below a threshold.

At action 212, upon receiving the confirmation message 210, the GNSS module 106 turns on the GNSS L1 receiver and begins processing L1 band signals. In some embodiments, turning on the GNSS L1 receiver 108 may include supplying power to the GNSS L1 receiver 108 or other component. The processing may include receiving a GNSS signal via the GNSS L1 antenna 110 and generating positioning data from the received GNSS data.

At action 214, the GNSS module 106 completes processing of L1 band signals and sends a message or signal 216 of such to the NTN module.

At action 218, upon receiving the message 216 that the GNSS module 106 has completed L1 band signal processing, the NTN module 102 can turn on or enable the NTN transmission as needed.

At action 220, when the NTN module 102 does enable the NTN transmission, the NTN module sends a message or signal 222 of such to the GNSS module 106.

At action 224, upon receiving the message 222 that the NTN transmission has been enabled, GNSS turns off or disables L1 band processing. In this manner, the NTN module and the GNSS module can coordinate operations such that an NTN transmission gap of a custom or selected duration can be created to accommodate a complete GNSS reception operation, rather than relying on existing default gaps that are defined in the transmission protocol or standards, which may be too short for the GNSS module to complete a reception operation.

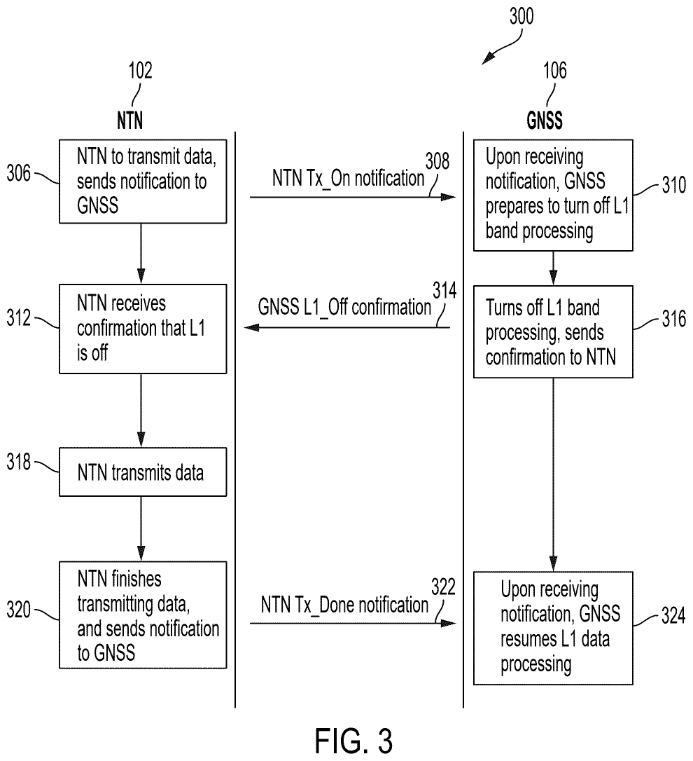

FIG. 3 depicts a communication flow 300 between the NTN module 102 and the GNSS module 106 over the NTN-GNSS interface 116 to alert the GNSS module 106 that NTN transmission is about to begin, according to one or more embodiment. At action 306, the NTN module sends a notification 308 to the GNSS module 106 of the NTN module's 102 intent to transmit data. In some embodiments, the notification 308 sent by the NTN module 102 may include parameters such as the band/channel of the upcoming transmission, the bandwidth, the power, duty cycle, transmission start time, transmission duration, among others.

At action 310, upon receiving the notification 308, the GNSS module 106 prepares to turn off L1 band processing. In some embodiments, the GNSS module 106 may finish receiving one or more data packets before the transmission start time indicated in the notification 308 from the NTN module 102. In some embodiments, the GNSS module 106 may switch from processing data received on the GNSS L1 band via the GNSS receiver 108 to processing data received on the GNSS L5 band via the GNSS L5 receiver 112. In some embodiments, recent L1 processing results may be passed to the L5 receiver to speed up L5 processing.

In some embodiments, in response to receiving the transmission notification from the NTN module 102, the GNSS module 106 may take an action to decrease a risk of interference with the NTN transmission. In this regard, in action 316, the GNSS module 106 blanks or disables L1 band reception and enables the L5 antenna to operate as an L5-only solution. A confirmation 314 of such action is transmitted to the NTN module 102. At action 312, the NTN module 102 receives the confirmation 314 that L1 band processing is off or disabled.

At action 318, the NTN module 102 begins to transmit data. In some embodiments, the NTN module 102 does not wait for the confirmation 314 that GNSS L1 band processing is off, and begins to transmit data at a start time even if the confirmation is not received 314 from the GNSS module 106. At action 320, the NTN module finishes transmitting data, and sends a notification 322 of such to the GNSS module 106.

At action 324, upon receiving the notification 322, the GNSS module may resume L1 data processing. For example, the GNSS L1 receiver 108 may be turned back on to receive data on the L1 band. In some embodiments, the GNSS module 106 may switch from processing data received via the GNSS L5 receiver 112 to processing data received via the GNSS L1 receiver 108. In this manner, the GNSS module 106 may coordinate its operation of the GNSS L1 receiver 108 based on the NTN transmission schedule. This enables the GNSS L1 to be utilized efficiently while decreasing the occurrence of degraded or erroneous data.

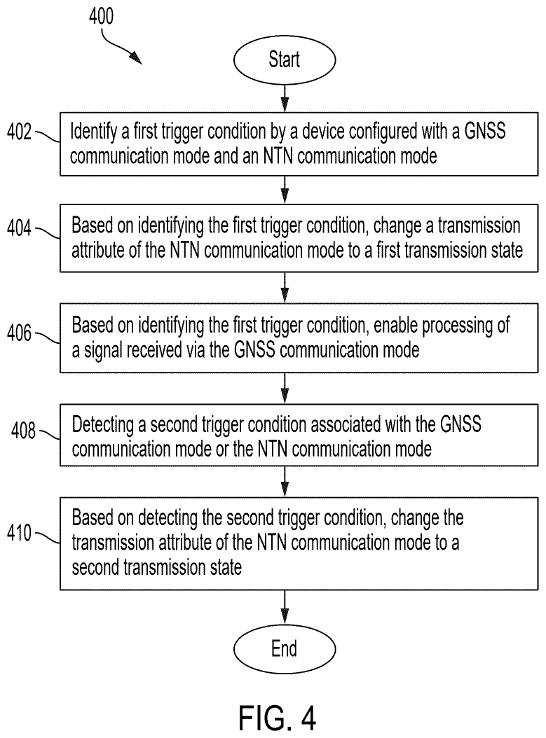

FIG. 4 depicts a flow diagram for a process 400 of GNSS and NTN communications according to one or more embodiments. The following example steps of the process 400 may be performed in any order, with additional steps, or with fewer steps than illustrated in this example. The process 400 starts, and at step 402, the electronic device 100 configured with a GNSS communication mode and an NTN communication mode identifies a first trigger condition. The device 100 may include the GNSS module 106 for supporting the GNSS communication mode and the NTN module 102 for supporting the NTN communication mode.

The GNSS module 106 may include at least the GNSS L1 receiver 108. In some embodiments, the GNSS module 106 also includes the GNSS L5 receiver 112. The NTN communication module 102 may include the NTN antenna 104.

In some embodiments, the first trigger condition may include receiving a request to operate the NTN communication mode in the first transmission state, in which the transmission by the NTN communication mode is disabled. In this regard, the NTN module 102 or scheduling engine 118 monitors for requests from the GNSS module 106 to disable NTN communication. The first trigger condition may include various other conditions or particular combination of conditions associated with the device and/or usage of the device. In some embodiments, transmission states of the NTN communication mode may include a status of transmission capabilities of the NTN communication modes. For example, in some embodiments, in the first transmission state, NTN transmission is disabled. In some embodiments, the first transmission state, NTN transmission occurs at a low transmission power level (e.g., below a threshold).

In some embodiments, the first trigger condition includes an attribute of positional data received at a first GNSS receiver of the GNSS module. In some embodiments, the first GNSS receiver is the GNSS L5 receiver 112. The GNSS module 106 may determine that the positional data received by the GNSS L5 receiver fails to provide positional fixes, or is otherwise of inadequate quality. Based on this determination, the GNSS module 106 may take action to receive and process data from the GNSS L1 receiver. In some embodiments, the first trigger condition may include a condition associated with a GNSS ephemeris, or ephemeris data. For example, the condition may be that the current GNSS ephemeris loaded in the device is about to expire (e.g., in a certain amount of time) or has already expired. In this regard, the GNSS module 106 may take action to download a fresh GNSS ephemeris using the GNSS L1 receiver 108.

At step 404, based on identifying the first trigger condition, the device changes a transmission attribute of the NTN communication mode to the first transmission state in which transmission by the NTN antenna 102 is disabled. In some embodiments, the transmission attribute may include one or more transmission settings or states of the NTN module. For example, in the first transmission state, the NTN module may institute a NTN transmission gap during which the NTN module does not transmit. In some embodiments, in the first transmission state, NTN transmission capabilities may be disabled.

At step 406, the device 100 (e.g., the GNSS module 106) enables the reception and/or processing of a signal received via the GNSS communication mode. In some embodiments, enabling reception of a signal received via the GNSS communication mode includes enabling the GNSS L1 receiver 108 which may include supplying power to the GNSS L1 receiver 108 or other components. Enabling processing of the GNSS may include receiving a GNSS signal via the GNSS L1 antenna 108 and generating positioning data from the received GNSS signal.

In this regard, the signal may be received by a GNSS L1 receiver 108 of the GNSS module 106.

At step 408, the device 100 (e.g., the NTN module 102) detects a second trigger condition, which indicates that NTN transmission is to be turned back on or enabled, and receiving of GNSS L1 data is to be halted or disabled. The second trigger condition may be associated with the GNSS communication mode, the NTN communication mode, or both. For example, the second trigger condition may include an indication that the GNSS module 106 has finished receiving the data and can be turned off. In some embodiments, the second trigger condition includes receiving a notification associated with the initiation of transmission by the NTN communication mode. For example, there may be a situation in which transmission by the NTN communication mode may take priority regardless of the status of the GNSS communication mode.

In some embodiments, the second trigger condition is based on a scheduled timing scheme. For example, the NTN module 102 may identify a preset duration during which NTN transmission is to be turned off before it is to be turned back on. In such embodiments, the second trigger condition is the expiration of the preset duration. In another example, in embodiments in which the first trigger condition includes a request made by the GNSS module 106, the request may include a requested duration. In such embodiments, the second trigger condition is the expiration of the requested duration. The second trigger condition may include various other conditions or combination of conditions associated with the device and/or usage of the device.

At step 410, based on detecting the second trigger condition, the device 100 changes the transmission attribute of the NTN communication mode to a second transmission state, in which transmission by the NTN communication mode is enabled. In some embodiments, upon detecting the second trigger condition, the GNSS L1 receiver is turned off and/or processing of GNSS L1 band data is halted. In some embodiments, when NTN transmission is enabled, GNSS L1 band processing is halted or disabled.

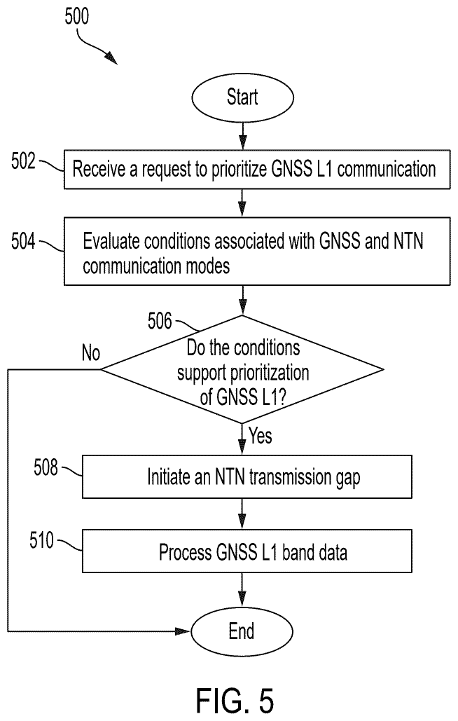

FIG. 5 depicts a flow diagram of a process 500 executed by the scheduling engine 118 to prioritize GNSS communication over an NTN communication according to one or more embodiments. Although the process of FIG. 5 is described as being performed by the scheduling engine 118, a person of skill in the art should recognize that the process 500 may be performed all or in part by the NTN module 102. The following example steps of process 500 may be performed in any order, with additional steps, or with fewer steps than illustrated in this example.

The process 500 starts, and at step 502, the scheduling engine 118 receives a request to prioritize GNSS L1 communication. In some embodiments, the request is transmitted by the GNSS module 106 in response to determining that there is data to be received on the GNSS L1 band via the GNSS L1 receiver for processing by the GNSS module 106. In some embodiments, the request may include a requested duration of an NTN transmission gap or estimated duration, which is the amount of time that the GNSS module 106 may need to receive and process the GNSS L1 band data.

At step 504, the scheduling engine 118 evaluates one or more conditions associated the GNSS and NTN communication modes. The conditions that may be evaluated may include, for example, the type of data to be received by the GNSS L1 receiver, how much time has passed since data was last received by the GNSS L1 receiver, how much time has passed since data was last transmitted by the NTN module, the current location of the device. In some embodiments, the scheduling engine 118 considers the status of currently stored GNSS data such as a GNSS ephemeris or positional fixes. Additional situational information or data associated with the device or usage of the device, may also be used in the evaluation, such as remaining battery life, whether there are other devices within the vicinity, whether the device is moving quickly, whether an application requiring GNSS data is active, and/or the like.

At step 506, a decision is made as to whether the one or more conditions support prioritization of GNSS L1 communication. In some embodiments, the scheduling engine 118 utilizes a set of rules to determine prioritization between GNSS L1 communication and NTN transmissions based on the detected condition(s). If the one or more conditions do not support prioritization of GNSS L1 communication, the process ends. If the one or more conditions do support prioritization of GNSS L1 communication, the process continues to step 508. For example, the conditions may indicate that the current ephemeris or ephemeris related data stored on the device may expire within a certain amount of time (or has already expired) and an updated ephemeris or ephemeris related data is to be downloaded onto the device. As this data is typically delivered via GNSS, and ideally on the GNSS L1 frequency band, it may be determined that such a condition supports prioritization of GNSS L1 communication over NTN transmission at that time. In another example, the conditions may indicate that the device is currently located in an unfamiliar location (based on historical location data associated of the device). This may indicate that having accurate GNSS data may be important at that time, and thus GNSS L1 communication may be prioritized.

At step 508, an NTN transmission gap is initiated. During the transmission gap, no signals are transmitted by the NTN module 102 on the NTN band. In some embodiments, NTN transmission may remain on, but with low transmission power (e.g., below a threshold). In some embodiments, transmission capabilities of the NTN module 102 may be disabled or turned off. For example, during the transmission gap, the NTN module 202 may turn off power to a transmitter in the NTN module 102. In some embodiments, the transmitter may remain powered but no signal is transmitted. In some embodiments, the transmission gap may be implemented by simulating a scenario as if the NTN signal is experiencing severe signal-to-noise ratio (SNR) loss.

At step 510, data on the GNSS L1 band is received and/or processed by the GNSS module 106 during the NTN transmission gap.

In some embodiments, the duration of the NTN transmission gap is based on the requested duration or estimated duration included in the request received at step 502. In some embodiments, the duration of the NTN transmission gap is based on a predetermined or preset amount of time. In some embodiments, the duration of the NTN transmission gap is based on a maximum duration of time for which NTN transmission can be disabled without being turned back on. For example, if the requested duration is longer than the maximum duration, NTN transmission may be turned back on at the end of the maximum duration rather than at the end of the requested duration.

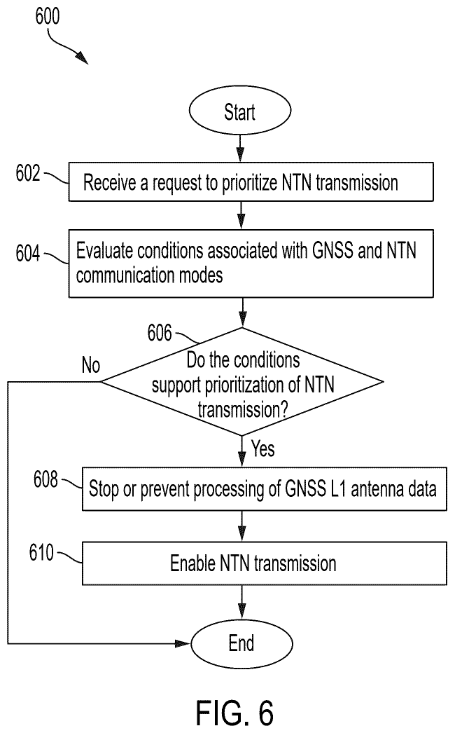

FIG. 6 depicts a flow diagram of a process 600 executed by the scheduling engine 118 to prioritize NTN communication over GNSS communication according to one or more embodiments. Although the process of FIG. 6 is described as being performed by the scheduling engine 118, a person of skill in the art should recognize that the process 600 may be performed all or in part by the NTN module 102. The following example steps of process 600 may be performed in any order, with additional steps, or with fewer steps than illustrated in this example. In some embodiments, the process 600 may occur when the GNSS L1 receiver 108 is currently in use and/or NTN transmission has been disabled, and the NTN module 102 detects a need to utilize NTN transmission. For example, the NTN module 102 may receive a request to transmit an SOS signal. This may take precedence over downloading GNSS data and thus NTN transmission is prioritized.

At step 602, the scheduling engine 118 receives a request to prioritize NTN transmission. The request may be transmitted, for example, by the NTN module 102 in response to determining the need for NTN transmission.

At step 604 the scheduling engine 118 evaluates one or more conditions associated with the GNSS and NTN communication modes. The conditions to be evaluated may be similar to the conditions evaluated in step 504 of FIG. 5.

At step 606 a decision is made as to whether the one or more conditions support prioritization of NTN transmission. In this regard, the one or more set of rules may be invoked to determine whether the NTN transmission should be prioritized over the GNSS communication. For example, if the type of data to be transmitted by the NTN module 102 is of a higher priority than the type of data being received by the GNSS L1 receiver 108, then NTN transmission may be prioritized. For example, an emergency signal transmitted by the NTN module 102 may have a higher priority than GPS data received by the L1 receiver 108.

If the one or more conditions do not support prioritization of NTN transmission, the process ends. If the one or more conditions do support prioritization of NTN transmission, then the process continues to step 608.

At step 608 processing of GNSS L1 data is stopped or prevented. For example, the GNSS module 106 may blank or disable L1 band reception and enable the L5 receiver to operate as an L5-only solution. At step 610, NTN transmission is enabled, and the NTN module 102 transmits NTN signals over the NTN band.

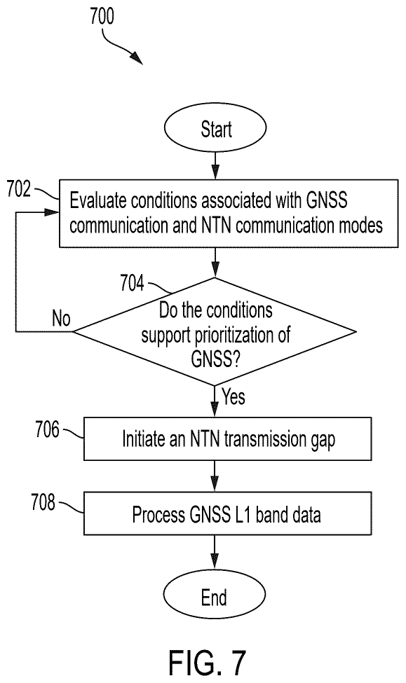

FIG. 7 depicts a flow diagram of a process 700 executed by the scheduling engine 118 for monitoring (e.g., automatically without human intervention) conditions for prioritizing GNSS communication over an NTN communication according to one or more embodiments. Although the process of FIG. 7 is described as being performed by the scheduling engine 118, a person of skill in the art should recognize that the process 700 may be performed all or in part by the NTN module 102. The following example steps of process 700 may be performed in any order, with additional steps, or with fewer steps than illustrated in this example.

At step 702, the scheduling engine 118 evaluates one or more conditions associated the GNSS and NTN communication modes. The evaluation may be conducted on a periodic (e.g., regular or irregular) basis. The conditions to be evaluated may be similar to the conditions evaluated in step 504 of FIG. 5.

At step 704, a decision is made as to whether the one or more conditions support prioritization of GNSS L1 communication over NTN transmission. If the one or more conditions do not support prioritization of GNSS L1 communication, the process continues to step 702 and continues to monitor and evaluate the conditions.

If the one or more conditions do support prioritization of GNSS L1 communication, the process continues to step 706. At step 706, an NTN transmission gap is initiated as described with respect to step 508 of FIG. 5. During the transmission gap, no signals are transmitted by the NTN module 102 on the NTN band. In some embodiments, transmission capabilities of the NTN module 102 may be disabled or turned off.

At step 708, data on the GNSS L1 band is received and/or processed by the GNSS module 106 during the NTN transmission gap.

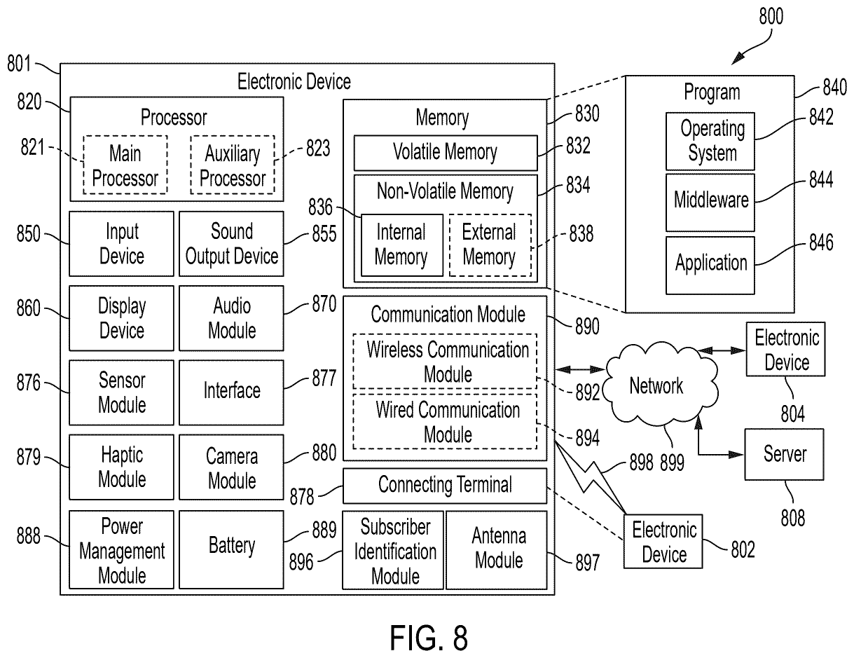

FIG. 8 is a block diagram of an electronic device 801 in a network environment 800 according to an embodiment. The electronic device 801 of FIG. 8 may be similar to the electronic device 100 of FIG. 1.

Referring to FIG. 8, the electronic device 801 in the network environment 800 may communicate with an electronic device 802 via a first network 898 (e.g., a short-range wireless communication network), or an electronic device 804 or a server 808 via a second network 899 (e.g., a long-range wireless communication network). The electronic device 801 may communicate with the electronic device 804 via the server 808. The electronic device 801 may include a processor 820, a memory 830, an input device 850, a sound output device 855, a display device 860, an audio module 870, a sensor module 876, an interface 877, a haptic module 879, a camera module 880, a power management module 888, a battery 889, a communication module 890, a subscriber identification module (SIM) card 896, or an antenna module 897. In one embodiment, at least one (e.g., the display device 860 or the camera module 880) of the components may be omitted from the electronic device 801, or one or more other components may be added to the electronic device 801. Some of the components may be implemented as a single integrated circuit (IC). For example, the sensor module 876 (e.g., a fingerprint sensor, an iris sensor, or an illuminance sensor) may be embedded in the display device 860 (e.g., a display).

The processor 820 may execute software (e.g., a program 840) to control at least one other component (e.g., a hardware or a software component) of the electronic device 801 coupled with the processor 820 and may perform various data processing or computations. In some embodiments, the NTN-GNSS interface 116 is partially or wholly implemented via the processor 820. In some embodiments, the scheduling engine 118 is partially or wholly implemented via the processor 820. In some embodiments, the process 820 performs one or more of the processes depicted in FIGS. 2-7.

As at least part of the data processing or computations, the processor 820 may load a command or data received from another component (e.g., the sensor module 876 or the communication module 890) in volatile memory 832, process the command or the data stored in the volatile memory 832, and store resulting data in non-volatile memory 834. The processor 820 may include a main processor 821 (e.g., a central processing unit (CPU) or an application processor (AP)), and an auxiliary processor 823 (e.g., a graphics processing unit (GPU), an image signal processor (ISP), a sensor hub processor, or a communication processor (CP)) that is operable independently from, or in conjunction with, the main processor 821. Additionally or alternatively, the auxiliary processor 823 may be adapted to consume less power than the main processor 821, or execute a particular function. The auxiliary processor 823 may be implemented as being separate from, or a part of, the main processor 821.

The auxiliary processor 823 may control at least some of the functions or states related to at least one component (e.g., the display device 860, the sensor module 876, or the communication module 890) among the components of the electronic device 801, instead of the main processor 821 while the main processor 821 is in an inactive (e.g., sleep) state, or together with the main processor 821 while the main processor 821 is in an active state (e.g., executing an application). The auxiliary processor 823 (e.g., an image signal processor or a communication processor) may be implemented as part of another component (e.g., the camera module 880 or the communication module 890) functionally related to the auxiliary processor 823.

The memory 830 may store various data used by at least one component (e.g., the processor 820 or the sensor module 876) of the electronic device 801. The various data may include, for example, software (e.g., the program 840) and input data or output data for a command related thereto. The memory 830 may include the volatile memory 832 or the non-volatile memory 834. Non-volatile memory 834 may include internal memory 836 and/or external memory 838.

The program 840 may be stored in the memory 830 as software, and may include, for example, an operating system (OS) 842, middleware 844, or an application 846.

In some embodiments, the one or more conditions and/or accompanied evaluation rules and criteria used for determining prioritization between GNSS L1 reception and NTN transmission may be stored in the memory 320.

The input device 850 may receive a command or data to be used by another component (e.g., the processor 820) of the electronic device 801, from the outside (e.g., a user) of the electronic device 801. The input device 850 may include, for example, a microphone, a mouse, or a keyboard.

The sound output device 855 may output sound signals to the outside of the electronic device 801. The sound output device 855 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 860 may visually provide information to the outside (e.g., a user) of the electronic device 801. The display device 860 may include, for example, a display, a hologram device, or a projector and control circuitry to control a corresponding one of the display, hologram device, and projector. The display device 860 may include touch circuitry adapted to detect a touch, or sensor circuitry (e.g., a pressure sensor) adapted to measure the intensity of force incurred by the touch.

The audio module 870 may convert a sound into an electrical signal and vice versa. The audio module 870 may obtain the sound via the input device 850 or output the sound via the sound output device 855 or a headphone of an external electronic device 802 directly (e.g., wired) or wirelessly coupled with the electronic device 801.

The sensor module 876 may detect an operational state (e.g., power or temperature) of the electronic device 801 or an environmental state (e.g., a state of a user) external to the electronic device 801, and then generate an electrical signal or data value corresponding to the detected state. The sensor module 876 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 877 may support one or more specified protocols to be used for the electronic device 801 to be coupled with the external electronic device 802 directly (e.g., wired) or wirelessly. The interface 877 may include, for example, a high-definition multimedia interface (HDMI), a universal serial bus (USB) interface, a secure digital (SD) card interface, or an audio interface.

A connecting terminal 878 may include a connector via which the electronic device 801 may be physically connected with the external electronic device 802. The connecting terminal 878 may include, for example, an HDMI connector, a USB connector, an SD card connector, or an audio connector (e.g., a headphone connector).

The haptic module 879 may convert an electrical signal into a mechanical stimulus (e.g., a vibration or a movement) or an electrical stimulus which may be recognized by a user via tactile sensation or kinesthetic sensation. The haptic module 879 may include, for example, a motor, a piezoelectric element, or an electrical stimulator.

The camera module 880 may capture a still image or moving images. The camera module 880 may include one or more lenses, image sensors, image signal processors, or flashes. The power management module 888 may manage power supplied to the electronic device 801. The power management module 888 may be implemented as at least part of, for example, a power management integrated circuit (PMIC).

The battery 889 may supply power to at least one component of the electronic device 801. The battery 889 may include, for example, a primary cell which is not rechargeable, a secondary cell which is rechargeable, or a fuel cell.

The communication module 890 may support establishing a direct (e.g., wired) communication channel or a wireless communication channel between the electronic device 801 and the external electronic device (e.g., the electronic device 802, the electronic device 804, or the server 808) and performing communication via the established communication channel. The communication module 890 may include one or more communication processors that are operable independently from the processor 820 (e.g., the AP) and supports a direct (e.g., wired) communication or a wireless communication. The communication module 890 may include a wireless communication module 892 (e.g., a cellular communication module, a short-range wireless communication module, or a global navigation satellite system (GNSS) communication module) or a wired communication module 894 (e.g., a local area network (LAN) communication module or a power line communication (PLC) module). A corresponding one of these communication modules may communicate with the external electronic device via the first network 898 (e.g., a short-range communication network, such as BLUETOOTH™, wireless-fidelity (Wi-Fi) direct, or a standard of the Infrared Data Association (IrDA)) or the second network 899 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 892 may identify and authenticate the electronic device 801 in a communication network, such as the first network 898 or the second network 89, using subscriber information (e.g., international mobile subscriber identity (IMSI)) stored in the subscriber identification module 896.

The antenna module 897 may transmit or receive a signal or power to or from the outside (e.g., the external electronic device) of the electronic device 801. The antenna module 897 may include one or more antennas, and, therefrom, at least one antenna appropriate for a communication scheme used in the communication network, such as the first network 898 or the second network 89, may be selected, for example, by the communication module 890 (e.g., the wireless communication module 892). The signal or the power may then be transmitted or received between the communication module 890 and the external electronic device via the selected at least one antenna. In some embodiments, the antenna module 897 includes the NTN module 102, the NTN antenna, the GNSS module 106, the GNSS L1 antenna 110, and the GNSS L5 antenna 114 depicted in FIG. 1

Commands or data may be transmitted or received between the electronic device 801 and the external electronic device 804 via the server 808 coupled with the second network 89. Each of the electronic devices 802 and 804 may be a device of a same type as, or a different type, from the electronic device 801. All or some of operations to be executed at the electronic device 801 may be executed at one or more of the external electronic devices 802, 804, or 808. For example, if the electronic device 801 should perform a function or a service automatically, or in response to a request from a user or another device, the electronic device 801, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 801. The electronic device 801 may provide the outcome, with or without further processing of the outcome, as at least part of a reply to the request. To that end, a cloud computing, distributed computing, or client-server computing technology may be used, for example.

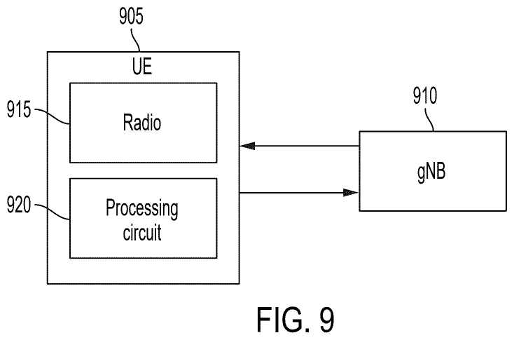

FIG. 9 shows a system including a UE 905 and a gNB 910, in communication with each other. The UE may include a radio 915 and a processing circuit (or a means for processing) 920, which may perform various methods disclosed herein, e.g., the techniques illustrated in FIGS. 2-7. For example, the processing circuit 920 may receive, via the radio 915, transmissions from the network node (gNB) 910, and the processing circuit 920 may transmit, via the radio 915, signals to the gNB 910. In embodiments, the UE 905 includes the NTN module 102, NTN antenna 104, GNSS module 106, GNSS L1 antenna 110, and GNSS L5 antenna 114 of FIG. 1.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above.

Statement 1: A method comprising: identifying a first trigger condition by a device configured with a global navigation satellite system (GNSS) communication mode and a non-terrestrial network (NTN) communication mode; based on identifying the first trigger condition, changing a transmission attribute of the NTN communication mode to a first transmission state and enabling reception of a signal received via the GNSS communication mode; detecting a second trigger condition associated with the GNSS communication mode or the NTN communication mode; and based on detecting the second trigger condition, changing the transmission attribute of the NTN communication mode to a second transmission state.

Statement 2: The method of statement 1, wherein transmission by the NTN communication mode is disabled or set to a power level that satisfies a threshold in the first transmission state and enabled in the second transmission state.

Statement 3: The method of statement 1 or 2, wherein the signal is received by a GNSS L1 antenna or receiver.

Statement 4: The method of one of statements 1-3, wherein the first trigger condition includes receiving a request to operate the NTN communication mode in the first transmission state.

Statement 5: The method of one of statements 1-4, wherein the first trigger condition includes receiving positional data at a first GNSS receiver associated with the GNSS communication mode.

Statement 6: The method of one of statements 1-5, wherein the second trigger condition includes receiving a notification associated with initiation of transmission on the NTN communication mode.

Statement 7: The method of one of statements 1-6, wherein the second trigger condition includes a completion of the reception of the signal.

Statement 8: The method of one of statements 1-7, wherein the second trigger condition includes the end of an identified duration of time.

Statement 9: A device, comprising: a first global navigation satellite system (GNSS) module; a non-terrestrial network (NTN) module; a processor; and a memory, wherein the memory stores instructions that, when executed by the processor, cause the processor to: identify a first trigger condition; based on identifying the first trigger condition, change a transmission attribute of the NTN module to a first transmission state and enabling reception of a signal received via the GNSS module; detect a second trigger condition associated with the GNSS module or the NTN module; and based on detecting the second trigger condition, change the transmission attribute of the NTN module to a second transmission state.

Statement 10: The device of statement 9, wherein transmission by the NTN module is disabled in the first transmission state and enabled in the second transmission state.

Statement 11: The device of statement 9 or 10, wherein the signal is received by a GNSS L1 antenna or receiver.

Statement 12: The device of any of statement 9-11, wherein the first trigger condition includes receiving a request to operate the NTN module in the first transmission state.

Statement 13: The device of any of statement 9-12, wherein the first trigger condition includes receiving positional data at a first GNSS receiver associated with the GNSS communication mode.

Statement 14: The device of any of statement 9-13, wherein the second trigger condition includes receiving a notification associated with initiation of transmission on the NTN module.

Statement 15: The device of any of statement 9-14, wherein the second trigger condition includes a completion of the reception of the signal.

Statement 16: The device of any of statement 9-15, wherein the second trigger condition includes the end of an identified duration of time.

Statement 17: A device, comprising: a first global navigation satellite system (GNSS) receiver; a non-terrestrial network (NTN) antenna; one or more processors; and at least one memory storing instructions that, when executed by the one or more processors, cause the processor to: receive a request associated with the GNSS receiver; initiate a transmission gap associated with the NTN antenna; initiate reception of a signal received via the GNSS receiver; detect a trigger condition; and based on detecting the trigger condition, enabling transmission by the NTN antenna.

Statement 18: The device of statement 17, wherein the request includes a requested duration of the transmission gap.

Statement 19: The device of statement 17 or 18, wherein the trigger condition includes a completion of the reception of the signal or the end of an identified duration of time.

Statement 20: The device of any of statement 17-19, wherein the trigger condition includes a second request associated with the NTN antenna.

What is claimed is:

1. A method comprising:
identifying a first trigger condition by a device configured with a global navigation satellite system (GNSS) communication mode and a non-terrestrial network (NTN) communication mode;
based on identifying the first trigger condition, changing a transmission attribute of the NTN communication mode to a first transmission state and enabling reception of a signal received via the GNSS communication mode;
detecting a second trigger condition associated with the GNSS communication mode or the NTN communication mode; and
based on detecting the second trigger condition, changing the transmission attribute of the NTN communication mode to a second transmission state.

2. The method of claim 1, wherein transmission by the NTN communication mode is disabled or set to a power level that satisfies a threshold in the first transmission state and enabled in the second transmission state.

3. The method of claim 1, wherein the signal is received by a GNSS L1 antenna or receiver.

4. The method of claim 1, wherein the first trigger condition includes receiving a request to operate the NTN communication mode in the first transmission state.

5. The method of claim 1, wherein the first trigger condition includes receiving positional data at a first GNSS receiver associated with the GNSS communication mode.

6. The method of claim 1, wherein the second trigger condition includes receiving a notification associated with initiation of transmission on the NTN communication mode.

7. The method of claim 1, wherein the second trigger condition includes a completion of the reception of the signal.

8. The method of claim 1, wherein the second trigger condition includes the end of an identified duration of time.

9. A device, comprising:
a first global navigation satellite system (GNSS) module;
a non-terrestrial network (NTN) module;
a processor; and
a memory, wherein the memory stores instructions that, when executed by the processor, cause the processor to:
identify a first trigger condition;
based on identifying the first trigger condition, change a transmission attribute of the NTN module to a first transmission state and enabling reception of a signal received via the GNSS module;
detect a second trigger condition associated with the GNSS module or the NTN module; and
based on detecting the second trigger condition, change the transmission attribute of the NTN module to a second transmission state.

10. The device of claim 9, wherein transmission by the NTN module is disabled in the first transmission state and enabled in the second transmission state.

11. The device of claim 9, wherein the signal is received by a GNSS L1 antenna or receiver.

12. The device of claim 9, wherein the first trigger condition includes receiving a request to operate the NTN module in the first transmission state.

13. The device of claim 9, wherein the first trigger condition includes receiving positional data at a first GNSS receiver associated with the GNSS communication mode.

14. The device of claim 9, wherein the second trigger condition includes receiving a notification associated with initiation of transmission on the NTN module.

15. The device of claim 9, wherein the second trigger condition includes a completion of the reception of the signal.

16. The device of claim 9, wherein the second trigger condition includes the end of an identified duration of time.

17. A device, comprising:
a first global navigation satellite system (GNSS) receiver;
a non-terrestrial network (NTN) antenna;
one or more processors; and
at least one memory storing instructions that, when executed by the one or more processors, cause the processor to:
receive a request associated with the GNSS receiver;
initiate a transmission gap associated with the NTN antenna;
initiate reception of a signal received via the GNSS receiver;
detect a trigger condition; and
based on detecting the trigger condition, enabling transmission by the NTN antenna.

18. The device of claim 17, wherein the request includes a requested duration of the transmission gap.

19. The device of claim 17, wherein the trigger condition includes a completion of the reception of the signal or the end of an identified duration of time.

20. The device of claim 17, wherein the trigger condition includes a second request associated with the NTN antenna.
